(19) United States
(12) Patent Application Publication
(10) Pub. No.: US 2003/0110395 A1
(43) Pub. Date: Jun. 12, 2003

(54) Controlled network partitioning using firedoors

(76) Inventors: David Leo Presotto, Berkeley Heights, NJ (US); Lookman Y. Fazal, Somerset, NJ (US)

Correspondence Address: Henry T. Brendzel, P.O. Box 574, Springfield, NJ, 07081, US

(21) Appl. No.: 10/090,075

(22) Filed: Mar. 1, 2002

Related U.S. Application Data
(60) Provisional application No. 60/339,059, filed on Dec. 10, 2001.

(51) Int. Cl. H04L 9/00

(52) U.S. Cl. 713/201

(57) ABSTRACT

A computer network is made more secure from attack attacks by partitioning the network into sub-networks and placing firedoors in association with the links that connect each sub-network to areas outside the sub-network. The firedoors scan traffic that flows through these links to identify—based on pre-stored pattern information—whether the traffic contains a virus, or some other attack, and blocks it from leaving the sub-network. The firedoors are coupled to a firedoor keeper, through which a firedoor informs the firedoor keeper whenever it detects unusual activity that suggests a successful virus breach of the protection intended for the gateway's network and, conversely, the firedoor keeper updates a pre-stored patterns file in all of the firedoors, or directs the firedoors to take specific action, e.g., blocking all traffic, whenever the firedoor keeper deemed it necessary.

### RELATION APPLICATION

This invention claims priority from U.S. Provisional Application No. 60/339,059, titled “Firewalls—Controlled Network Partitioning,” filed Dec. 10, 2001.

### BACKGROUND

This invention relates to computer networks and, more particularly, network security and recovery from intrusions.

FIG. 1 depicts a computer network that encompasses Internet 100, an intracorporate network 200 of a first enterprise, for example, corporation X, and an intracorporate network 300 of a second enterprise, for example, corporation Y. The illustrative network 200, consists of three component networks of corporation X (210, 220, and 230) that are each at a different geographical location. The component networks of corporation X are interconnected through links that connect to gateway routers within each of the locations, and these component networks are also connected to Internet 100. The connection to Internet 100 is also through the gateway routers.

At times, one enterprise may have a special relationship with another enterprise, for example when they are partners relative to some endeavor, and in such situations, these enterprises sometimes establish a dedicated communication link between themselves. This situation is represented in the FIG. 1 arrangement by the link from the gateway of component network 230 to the gateway of partner network 300.

Within each component network, such as component network 210, there is the aforementioned gateway router, such as gateway router 211, and a plurality of switches, such as switches 212-215. The switches and the gateway router are interconnected to form a network, and each switch services a plurality of processing units, including units such as mail server 216, data server 217, and personal computers, or workstations, such as PC 218.

Illustratively, all of the FIG. 1 networks communicate in packets, employing an IP protocol. It should be understood, however, that the specific mode of communication within and across the networks is not a factor in the principles of the invention disclosed herein. It should also be understood that the principles disclosed herein do not depend on whether switches are employed or routers are employed. The term switches as used herein intends to encompass routers.

Interloper attacks are a major concern with computer networks. The concern is that interlopers can gain access to computers on the network and steal information, alter information, erase data and program files, and carry out many other kinds of mischief. To combat this problem, administrators of computer networks have resorted to reducing the number of entry points into their networks and to placing “firewalls” at each of the remaining entry points.

The goal of firewalls, of course, is to protect valuable resources on the protected network behind the firewall, such as network 200, or component network 210, while allowing communication and access with systems located on an unprotected network such as Internet 100. Typically, the firewall is implemented in software that is executing in the gateways of the protected network, such as in gateway 211, to block attacks from the unprotected network by providing only limited, controlled, and monitored services to users that wish to communicate with the protected network from outside the protected network. Placing the communication monitoring and control at the one, or few, gateways of the protected network allows for relatively easy administration of the gateway, and the network's, security policy.

In fact, there are two reasons why gateways appear to be a good solution. First, as indicated above, a protected network has many fewer gateways than computers. That means fewer elements to administer. Second, and perhaps more importantly, the software that the gateway computer maintains is perhaps orders of magnitude less voluminous and less complex than the software in the network computers. That translates to simpler administration tasks. Moreover, this software is not diverse, and is not changing like the software of, for example, PCs belonging to users within the protected network who may wish to add new software, or to upgrade existing software. This is a very important consideration, since viruses enter a computer system and do much of their damage through what might be considered “trap doors,” or “bugs,” is resident software. That is, an unintended capability of resident software, or a capability that exists for beneficial uses, that can be used for causing damage. As the number of software modules on a computer increases, as the complexity of the software increase, and as the updating or changing of software is more frequent, the more likely it is that the computer will have a trap doors through which a virus infection may occur.

To give one example, Microsoft's WORD program creates text documents that have macros which, when executed, can open files, erase files, etc. Should a computer system import a WORD document that contains a macro that erases all files of a computer, an intolerable damage might occur. Programs that enable emails are another example. Transacting work with the help of email has become ubiquitous in American industry, in part, because email can carry attachments with its message, such as WORD documents, as well as other types of documents that contain macros, and even executable programs. Unfortunately, this beneficial attribute of email is also its Achilles heel. Once an email recipient is induced to execute a virus-laden executable program attachment, there is practically no limit to the amount of damage that the virus can cause; including mailing itself to every email address found in the infected computer.

Firewalls can, perhaps, be designed that will stop almost all interlopers but, necessarily, that use of such a firewall would result in an almost a complete isolation of the computer network from all other networks. That is typically not acceptable and, therefore, firewalls usually operate by evaluating all passing communication against a set of potential-problem markers. These may be a request for a particular kind of service, a data query, an incoming executable file, etc. When such a marker is identified, the gateway takes action in accordance with a predetermined script. It is the gateway administrator who is charged with maintaining the most current set of “potential-problem” markers and the appropriate responses. Obviously, this is a continuing responsibility because new threads are continually created and discovered.

The above-described prior art architecture has two significant drawbacks. First, it fails to recognize that almost all viruses do get through the gateway. This is because most current viruses are very contagious. They spread so fast that, at least with respect to large corporations that have many computers (some have thousands of computers), a virus is passed to one of the computers behind the firewall before the firewall's administrator has a chance to install an appropriate modification to the set of potential-problem markers. Second, it fails to recognize that the gateways are not really the only avenues by which information is imported into a computer network. It is not unusual for an employee to install files into the computer system by means of various storage media, such as floppy disks, CDROMs, PDAs, etc. Indeed, some corporations actually permit employees to carry portable computers wherever they go and then connect to the network through docking stations.

Unfortunately, once a virus breaches the protection intended by the firewall, it can easily and very quickly spread to all of the network computers. Further, sanitizing a network that has been infected is very difficult because the virus re-infects cleaned machines. Also unfortunately, corporate networks with large numbers of computers are more susceptible to viruses than small networks simply by virtue of the fact that more computers are connected to the network, and the damage created by virus causes more damage in such large networks.

Of course, software exists that can be placed within each computer to cleanse that computer of existing and arriving known viruses. The problem with this solution is that up to date detection software must exist and run on each of the network computers before the virus gets a chance to infect. While distributed means exist for downloading such software, they are fallible, require a significant amount of expertise and energy on each end user, and often take effect after the damage has occurred. In the case of portable computers that are detached from the environment for long periods, the software may be seriously out of date.

### SUMMARY

The problems of prior art computer networks are ameliorated, and an advance in the art is achieved by recognizing the fact that, with current technology, viruses and other attacks do get through to the networks, and by introducing firedoors to nullify or dampen the effect of infection once it does happen. By partitioning a network that is to be protected into sub-networks and placing firedoors at the interfaces between the sub-networks, infection to each such sub-network is contained. The firedoors scan traffic that flows out of a sub-network to identify—based on pre-stored pattern information—whether a machine is engaged in nefarious activity. They then take action by reporting the alarm to a firedoor keeper and, if the action associated with the matched pattern requires it, by isolating the offending machine, or otherwise containing the attack.

The firedoor keeper is a processing unit that updates the patterns and actions in its associated firedoors. It also provides an administrative interface to add new patterns to firedoors and to display alarms to administrators. New patterns can also be added electronically, from trusted sources.

The firedoors are always in the network and always updated as soon as their keeper is told of new viruses. Thus, they provide ever-present infection scanning and control, without requiring interaction with the computers and end users. Also, since the keeper collects alarms from firedoors throughout the entire network, previously unknown attacks can more easily be recognized.

In an alternative embodiment, the firedoors scan traffic that flows into a sub-network and, when necessary, blocks it from entering the sub-network. Checking both incoming and outgoing traffic is also possible.

### BRIEF DESCRIPTION OF THE DRAWING

FIG. 1 presents an illustrative, prior art, network arrangement;

FIG. 2 depicts one embodiment of component network 210 of the FIG. 1 network arrangement, as modified in accord with the principles disclosed herein;

FIG. 3 is an illustrative block diagram of a firedoor element employed in the FIG. 2 arrangement;

FIG. 4 is a flowchart illustrating the steps used to implement a firedoor process in accordance with the present invention;

FIG. 5 is a block diagram of an illustrative embodiment of a firedoor keeper;

FIG. 6 is a flowchart illustrating the steps used to implement a firedoor keeper process in accordance with the present invention; and

FIG. 7 depicts another embodiment of component network 210 of the FIG. 1 network arrangement, as modified in accord with the principles disclosed herein.

### DETAILED DESCRIPTION

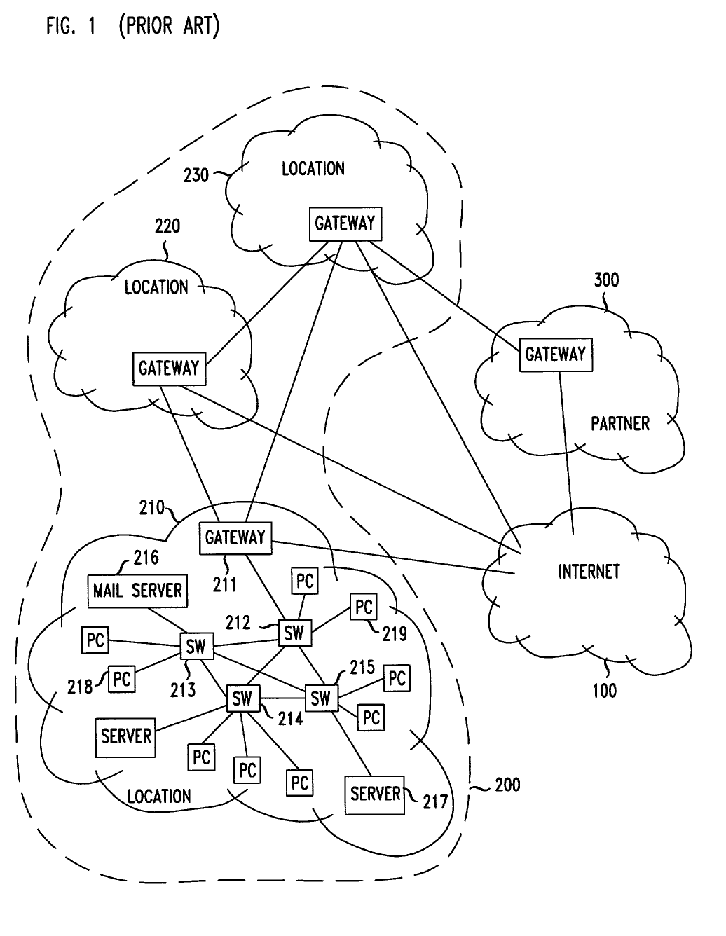

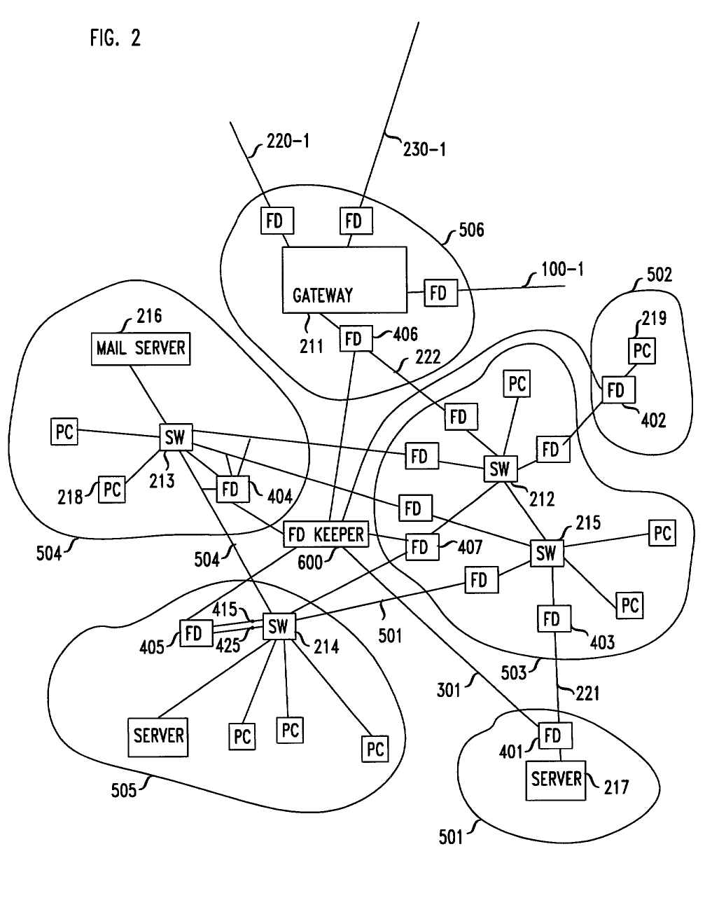

FIG. 2 presents one embodiment of component network 210 of FIG. 1 that is modified in accordance with the principles of this invention (for sake of exposition simplicity, the remainder of the detailed description refers to component networks 210, 220, and 230 as networks).

The fundamental assumption that is made relative to this disclosure is that a virus, or some other malfeasing data (data that constitutes a threat of harm) will, at some point, enter a network, such as network 210. It may enter through a floppy disk that is inserted into a computer within network 210, through a computer that is connected to a port of the network, through gateway 211, or through some other means. Accepting the premise that a virus can enter a network despite diligent efforts to block it, measures are proposed herein for preventing its subsequent spread throughout the network.

To this end, each component network as the modified network 210 is partitioned into sub-networks, all traffic over all interconnecting links of each sub-network is monitored and controlled by a firedoor module, and the firedoor modules communicate with a firedoor keeper that coordinates their actions.

Illustratively, network 210 is partitioned into sub-networks 501, 502, 503 504, 505, and 506, and all firedoors in the sub-networks communicate with firedoor keeper 600. The embodiment depicted in FIG. 2 is one where the firedoors aim to prevent the spread of malfeasing data that is outgoing of a sub-network. It should be noted that each of the sub-networks associated with firedoor keeper 600 are controlled by the same enterprise. By way of comparison, links 100-1, 220-1 and 230-1 constitute links to external networks (or sub-networks)—that is, networks or sub-networks that are not controlled by the same enterprise and therefore not associated with firedoor keeper 600.

Sub-network 501 encompasses only server 217, which is coupled to switch 215 of sub-network 503 through link 221. In accord with the FIG. 2 embodiment, traffic from switch 217 to server 215 is monitored and controlled by firedoor element 401 that is interposed in link 221. The function of firedoor element 401 is to block the flow of malfeasing data into sub-network 503, the knowledge about which is received from firedoor keeper 600. Examples of malfeasing data are specific executing code segments that are virus programs, and improper requests for proprietary information. The malfeasing data information that is provided by firedoor keeper 600 is maintained in a patterns file within firedoor 401 (described in more detail below), in the form of tuples. Each tuple describes a data pattern that is to be identified, and an action that is to be carried out when the monitored pattern is discovered.

In FIG. 2, firedoor element 401 is connected to firedoor keeper 600 via line 301, which is a bi-directional line. The implication of the drawing is that line 301 is a dedicated line that is distinct from any other link of network 210. That is certainly an option in constructing the FIG. 2 arrangement. It has the advantage that no interloper can gain access to line 301 and, therefore, the communication over line 301 need not be secure. Alternatively, line 301 of FIG. 2 can be viewed as a logical connection between firedoor element 401 and firedoor keeper 600, with the actual connection taking place with a multilink path that traverses switches in any number of sub-networks, or even networks, since the location of firedoor keeper 600 is not restricted at all. In such a realization, however, it must be recognized that the communication between firedoor keeper 600 and any and all firedoor elements or firedoor modules must be secure, and encryption is one acceptable means for obtaining the necessary security. Generally, it is expected that the preferred embodiment will employ encryption rather than dedicated lines, because that avoids the need to install dedicated lines.

Sub-network 502 is structurally similar to network 501. It encompasses merely PC 219, and firedoor element 402, which is interposed in the link between the PC and switch 212. As in sub-network 501, the firedoor element of network 502 is coupled to firedoor keeper 600.

Sub-network 503 encompasses switches 212 and 215 and all PCs that connect to these switches (save for PC 219, which is in sub-network 502). It has numerous links that connect to the different sub-networks of network 210, and each link includes an interposed firedoor element, such as elements 403 and 407. All of the firedoors in sub-network 503 have a connection to firedoor keeper 600, although for sake of clarity, only the connection to firedoor 407 is shown.

It is noted that sub-network 503 differs from sub-networks 501 and 502, in that networks 501 and 502 each have only one processing unit (server 217, and PC 219, respectively), and that processing unit is also the sole periphery element of its sub-network. For purposes of this disclosure, the term “periphery element” should be understood to mean a processing unit of a sub-network that is connected, via an associated link, either to a processing unit of another sub-network controlled by the same enterprise or to an external network. In contradistinction, network 503 is a multi-element network that comprises two interconnected switches and a plurality of PCs, and it is the switches that form the periphery elements of the sub-network. While all of the switches of sub-network 503 are also periphery elements, it can be easily envisioned that only some of the switches in a sub-network would also constitute periphery elements. While it doesn't clearly come through in sub-network 503, one can realize that a sub-network can have more processing units (e.g. PCs) than links that require a firedoor, or vice versa. A network that is partitioned so that a sub-network has many processing element but only few firedoors has the benefit of needing fewer firedoors. On the other hand, including a large number of processing units within a sub-network exposes all of those processing units to virus attack, should a virus manage to enter the sub-network. The decision as to how many partitions to create in a given network belongs to the practitioner.

Sub-network 506, like sub-networks 501 and 502, has a single processing element; that is, gateway 211. While the gateway 211 function of protecting network 210 from malfeasing data is not really needed in the FIG. 2 arrangement, it remains in the FIG. 2 drawing for illustrative purposes as merely another processing unit. In other words, relative to the firedoor functionality that is to be imparted to network 506, gateway 211 might be a server, a PC, or any other processing unit. The firedoors employed in sub-network 506 are the same as the firedoors employed in sub-network 503; and they, too are connected to firedoor keeper 600 (although only firedoor 406 is shown so connected).

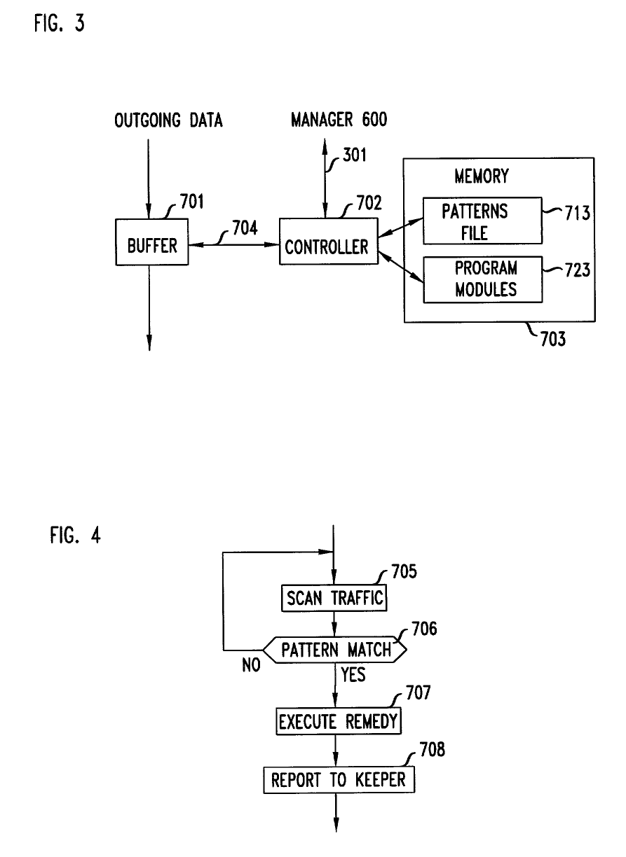

A block diagram of a firedoor element is presented in FIG. 3. Illustratively, it is the block diagram of firedoor element 401 (which is identical to the firedoor elements in sub-networks 502, 503, and 506). Input data from server 217 that is destined to sub-network 503 is stored in buffer 701, and the data in buffer 704 is analyzed by controller 702 via path 704. More specifically, controller 702 compares the data in the buffer to candidate patterns maintained in patterns file 713. When a candidate pattern is found in the data of buffer 701, controller 702 takes action in accordance with the action that is specified for the candidate pattern in the patterns file. This may include, for example, modifying the data to remove the threat, or blocking/removing an entire executable code module, resulting in sanitized data in buffer 701. The sanitized data is then sent out of buffer 701 into sub-network 503.

It might be remembered that the data is in the form of packets, and it may be noted that the scanning performed by controller 702 is not limited to the payload of the packets. It includes scanning of the header, which provides the ability to focus on a particular source, or destination. Further, it may be noted that a message from a source to a destination typically comprises more than one packet, and that when a part of a message is blocked and a destination receives less than an entire message, the destination disregards the entire message.

A flow diagram of the process carried out in firedoor 401 is presented in FIG. 4. Packet data that flows through buffer 701 is scanned by controller 702 in step 705. Controller 702 matches all packets against patterns in patterns file 713. As long as a match is not found in step 706, control returns to scanning step 705. When a match is found, control passes to step 707 which executes whatever action is dictated for the matched pattern by file 713. Since the behavior of firedoor 401 is controlled by program modules 723 and the actions are specified by file 713, the number and type of actions is extensible. It is expected, however, that firedoor embodiments will at least include the following actions:

1. discard the packet

2. add more patterns/actions to patterns file 713 and

3. queue notification of a match to the firedoor keeper.

4. any combination of the above.

Other capabilities may be

5. disallow all mail messages

6. disallow all web traffic

7. disallow all traffic from/to some group of processing units (e.g., computers),

Action 2, above, that of adding new patterns/actions, can be used to handle subsequent packets that normally might not have been affected. For example, should particular PC send an email packet corresponding to a known virus, one might wish to block all subsequent emails from that system. To accomplish that, a pattern can be added that recognizes email packets from that particular PC, and the “action” associated with that pattern will be to discard the email packets.

The patterns contained in file 713 are known virus patterns and, advantageously, suspicious data patterns. Additionally, some embodiment of firedoor 401 take advantage of the presence of program modules 723 in the firedoor and impart to these modules some analysis capabilities to determine whether, in fact, a suspicious pattern or behavior is indicative of a virus. Regardless of whether a firedoor contains such capabilities, the firedoor sends a message to firedoor keeper 600 whenever action is taken relative to data passing through firedoor 401. This is reflected in FIG. 4 through step 708.

In the case of a firedoor associated with a switch, as in sub-network 505, all patterns with actions 1 and 2 have analogues applied to the switch configuration. In such cases, part of adding/removing of any pattern to/from the firedoor implies that the firewall is sending a configuration change to the switch via a private link.

Notifications must eventually find their way to the firedoor keeper. However, blind transmission of every match from all firedoors to the keeper could easily pose a threat to the network. Therefore, all notifications must be flow controlled by the firedoor keeper. There are many ways to do this. One possibility would have the firedoor keeper periodically poll the firedoors for notifications, thus reading whatever messages are kept in the firedoor for the keeper's retrieval. Another would have the firedoor keeper pass to each firedoor a number of messages that it can send to the keeper before the keeper acknowledges receipt and thus authorizes the transmission.

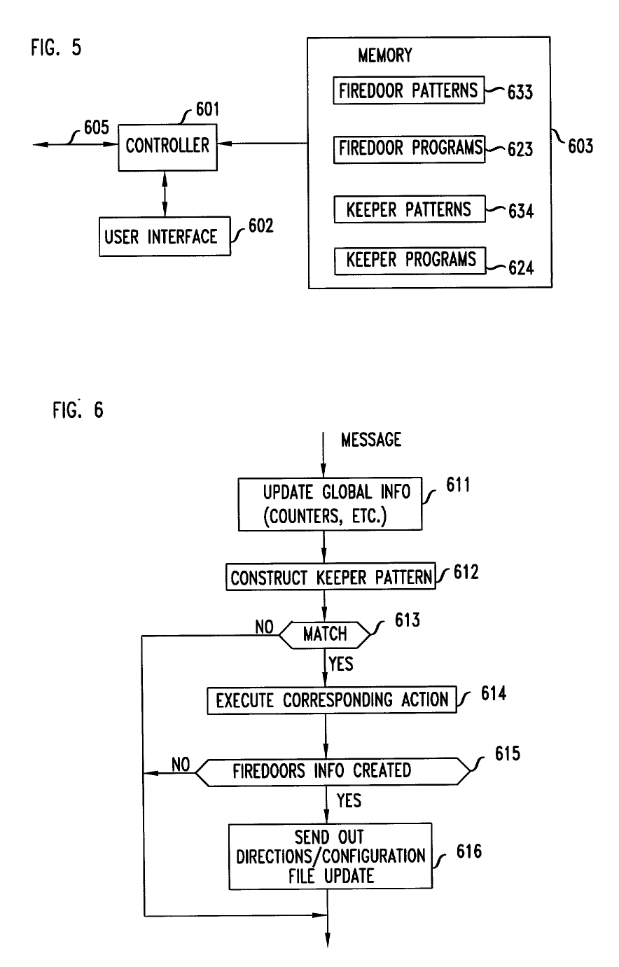

FIG. 5 presents one block diagram of firedoor keeper 600. The firedoor keeper comprises processor 601 that converses via administrative interface 602 with a human administrator, and via its private (or encrypted) connections with the firedoors, through path 605. Memory 603 that is associated with processor 601 includes firedoors' patterns file 633 and firedoors' program modules 623, which are the files that the keeper downloads to all firedoors when appropriate. These files can be updated via the administrative interface and are downloaded to all firedoors whenever they are updated. The keeper patterns file 634 and the keeper program modules 624 are used to drive the keeper's response to notifications from the firedoors. Memory 603 also maintains global information about past messages from firedoors and, consequently, when a message from a firedoor arrives that informs keeper 600 that, for example, “pattern #15 was detected by firedoor 401,” keeper 600 can convert it, by appending data from the global information (basically, counters, and other long term state information) to, for example,

#15;99;10,

which means

pattern #15 notification arrived, and

there have been 99 such notifications

from 10 different firedoors.

Correspondingly, patterns file 634 may include a pattern of the form

#15;>100;>8;disable web traffic,

which means “create a new firedoor pattern that disables web traffic when pattern #15 is received AND there are more than 100 such received reports AND the reports arrived from more than 8 firedoors.” Thus, in the above example, when firedoor 401 sends the message “pattern #15 was detected by firedoor 401,” a new firedoors pattern is NOT established by keeper 600 (because the>100 condition is not met).

A minimal set of actions employed in the keeper patterns file might be:

1. notify administrator via administrative interface,

2. add new patterns to the firedoors patterns file 633, and

3. modify a counter

4. some combination of the above.

Other actions are, of course, also possible.

Thus, the keeper can automatically respond to an attack inherent in a pattern of notifications, or escalate the responsibility up to the administrator. In may be noted that program modules 624 may employ more sophisticated analysis than mere simple pattern matching, with the level of sophistication in the analysis being left, of course, to the practitioner to decide.

FIG. 6 presents an illustrative flowchart of one process carried out by the FIG. 5 apparatus, where packets arrive at firedoor keeper 600 via link 605. In step 611, controller 601 increments whatever counters are relevant to the message, and updates report files that are relevant to the message. Step 612, which follows, constructs a pattern akin to the illustrative pattern shown above in preparation for scanning keeper patterns file 634. Step 613 scans the file and, when a logical match is found, passes control to step 614. If a logical match is not found, the process terminates. As an aside, by “logical match” what is meant is that a constructed pattern #15;101;10, matches pattern #15;>100;>8;disable web traffic, since 101>100 and 10>8.

Step 614 executes the action specified in the matched pattern (in the example above, “disable web traffic”) and passes control to step 615. Step 615 determines whether the action created a new pattern or some other directive for the firedoors. If so, control passes to step 616, which sends out the appropriate information to the firedoors. If there is no transmission to the firedoors,—for example, if the executed action is merely a reporting to the firedoor keeper's administrator—then the process terminates.

It should be realized that other processes are carried out, at times, within firedoor keeper 600. For example, there is a process related to the administrator interface, which allows modifications to any of the files in memory 603 and which permits sending of new patterns or directives to the firedoors. In some embodiments, firedoor keeper 600 may also allow the administrator to effectively interact with the user interface remotely, with proper security authentication, of course. It can be even by having gateway 211 serve as a proxy administrator.

It is noted that the above approach allows malfeasing data that was previously unknown to exist a sub-network and possibly infect a number of computers in one or more other sub-networks. However, once firedoor keeper 600 informs all firedoors of the appropriate action to take, that malfeasing data is prevented from spreading further, and the network's administrators can then proceed to remove the malfeasing data from the few infected computers.

Thus, through line 301 firedoor keeper 600 receives information from the different firedoor elements or firedoor modules that connect to firedoor keeper 600 and, in the reverse direction, firedoor keeper sends updates for patterns file (e.g., 713), updates for the program modules (e.g., 723), and directives to the different firedoor elements or firedoor modules that connect to firedoor keeper 600.

Sub-network 504 comprises switch 213 that supports a number of PCs, e.g., PC 218, and mail server 216. Switch 213 is the periphery element of sub-network 504. The sub-network protection is handled by firedoor module 404, which is coupled to the links that connect sub-network 504 to the other sub-networks of network 210. Firedoor module 404 functionally comprises a number of firedoor elements that, not unlike firedoor element 401, can be implemented with a controller that is sensitive to the traffic of all of the links to which it is connected, and with a single memory that stores the patterns file and the program modules. Since firedoor module 404 is not interposed in the signal path to switch 213, it is left to switch 213 to sanitize, or to simply block malfeasing data. This is achieved by including a control port at switch 213, through which firedoor 404 directs the switch as to actions that it is to take. This requires use of a switch that has the capability to block data, and such switches are commercially available; for example, the Cajun P120 Workgroup switch made by Avaya corp. Typically, however, today's switches are limited to actions that are less discriminating than what is possible with firedoor 401; and in particular, they are not sensitive to specific payload patterns of packets. Rather, such switches are limited to actions like

1. Disable all communications through the switch;

2. Disable all communications with a specific address (switch port or IP address), or only to a specific address, or only from a specific address; or

3. Disable all communication of a particular type, such as email and/or web access.

It is noted that since the FIG. 2 embodiment aims to prevent the spread of outgoing malfeasing data, the placement of firedoor module 404 downstream from switch 213 while attempting to control the actions of switch 213 is a bit of a problem. Basically, such placement allows at least one instance of the malfeasing data to successfully escape sub-network 504. This, however, is not considered much of a problem, since switch 213 is then informed to block all subsequent attempts to export the malfeasing data to outside sub-network 504, and will do so. Informing firedoor keeper 600 of this single escape allows firedoor keeper 600 to direct all other firedoors of the type employed in sub-network 504 to instruct the switches they control to block all instances of the malfeasing data, thereby isolating the malfeasing data to the originating sub-network and to the single escaped instance (which may, or may not be successful in infecting the destination computer).

Sub-network 505 comprises switch 214 that supports a number of PCs and a server. Here, too, the switch is the periphery element of the sub-network. The sub-network protection is handled by firedoor module 405 that is coupled to a mirroring port 415 of switch 214 and to control port 425 of switch 214. The mirroring port duplicates (mirrors) all traffic that flows through a specified port of the switch. The port is specified by firedoor module 405 through control port 425.

Functionally, firedoor module 405 is similar to firedoor module 404, with the only difference being that firedoor module 404 is directly connected to all of the links that enter sub-network 504, whereas firedoor module 405 is effectively coupled (rather than directly connected) to a specified one (rather than simultaneously to all) of the links that enter sub-network 505. Other than the control that is exercised by firedoor module 405 in the mirrored port selection process, the processes executed by firedoor module 405 are identical to those executed by firedoor module 404.

In embodiments where a periphery switch has a single mirroring port but has more than one link that connects to another area—as is the case in connection with switch 214, which has three links connecting to other sub-networks, e.g., links 501 and 504)—the operation of module 405 cannot be applied to all of the data that flows through such links. The information that flows to the mirroring port is, necessarily, a sampling of the data. Even in embodiments where sampling is not a necessity, one may choose to sample the data rather than analyze all of it. This can be accomplished by switch 214 sending only a sampling of the data flowing through a selected port, or firedoor module 405 may do the sampling. The sampling approach increases the potential of malfeasing data being exported out of sub-network 505, because not only is one exported instance necessary to detect the fact that malfeasing data is being exported, but it is also necessary that the malfeasing data instance that is being exported happens to use an output port of switch 214 that is being monitored. As indicated above, however, the principles of this invention contemplate that some spreading of malfeasing data can occur, and that the spreading can be stopped once detected, and the network can thereafter be sanitized.

One advantage of the arrangement depicted in sub-network 505 is that firedoor module 405 can be directed to look at every port of switch 214; not just ports that connect to links coming from other areas. This allows one to provide a measure of protection for communication between processing units within the sub-network. That is, if a known virus infects a particular PC within sub-network 505, there is a chance that its spread to other PCs within the sub-network can be detected by firedoor module 405, and stopped by directing switch 214 to block all messages that include the spreading virus.

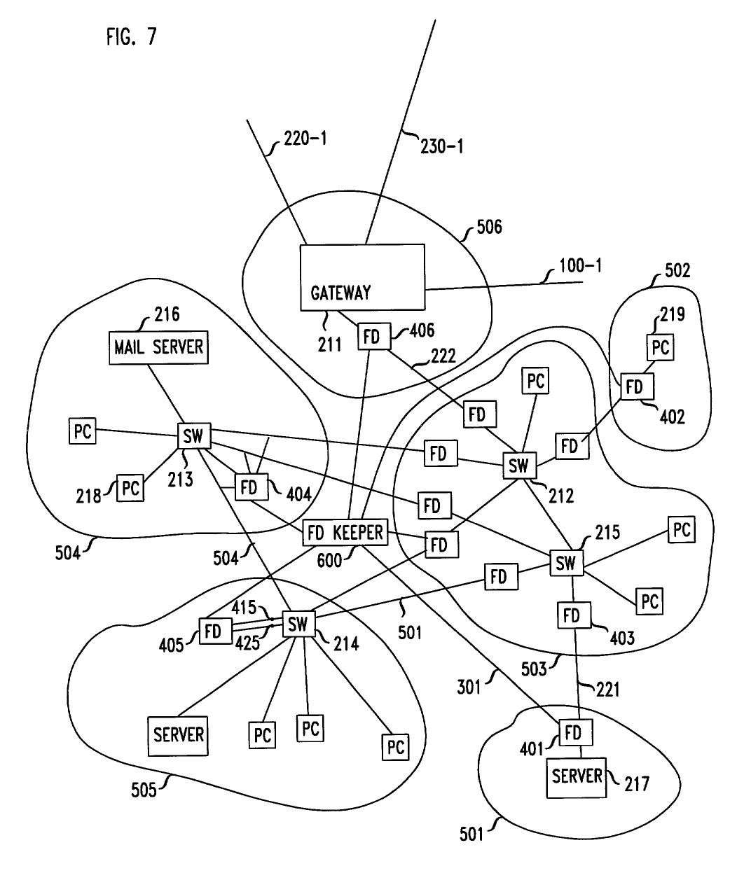

FIG. 7 presents an embodiment that controls traffic that is incoming to the various sub-networks of network 210, rather than outgoing from the various sub-networks. Macroscopically, the FIG. 7 embodiment differs from the FIG. 2 embodiment only in that the firedoors in FIG. 2 that connect to other networks (i.e., networks 100, 220, and 230) are not used in FIG. 7 because gateway 211 already serves that function. On a more detailed level, firedoor module 404 instructs switch 213 to block traffic as before, but an embodiment can be created with a buffer placed in each link that connects an area to switch 213, and this buffer can be used to inject a delay, and this insures that that even a single instance of a known malfeasant data will not be passed by switch 213. The same approach can be taken in connection with switch 214 in sub-network 505.

It may be worth mentioning that a partitioned network 210 may employ both firedoors that prevent spread of malfeasing data that is outgoing and firedoors that prevent spread of malfeasing data that is incoming. In such an implementation, however, one must be careful that no unprotected pathways result. Lastly, it is worth mentioning that firedoors can be employed that prevent the spread of malfeasing data in both incoming and outgoing directions.

1. In a network controlled by an enterprise but having at least one link for establishing a connection to a network not controlled by the enterprise, comprising:
a plurality of sub-networks, wherein
each sub-network i includes at least one processing unit,
at least one processing unit of at least one of said plurality of sub-networks is a periphery switch of said network and is connectable to one or more other networks that are not controlled by said enterprise, and
each sub-network i employs Nᵢ links, Nᵢ being an integer greater than 0, for communication between said at least one processing unit and one of another processing unit within a common sub-network, a processing unit within another sub-network of the network controlled by the enterprise, and
a firedoor module i, associated with said Nᵢ links, that includes means to block effects of all known malfeasing data addressed to flow through said Nᵢ links of said sub-network i.

2. The arrangement of claim 1 where said firedoor module i is further selectively adapted to block traffic seeking to flow out of said sub-network, out of said network i, or both in and out of said network i when said firedoor module i concludes that a likelihood exists that malfeasing data aims to flow out of said sub-network i.

3. The arrangement of claim 1 where more than one of said Nᵢ links is connected to one of said one or more periphery elements of said sub-network i.

4. The arrangement of claim 1 where said Nᵢ links are grouped into J groups, each group associated with a different one of said periphery elements, said firedoor module i consists of J submodules, each associated with a different group of said Nᵢ links, and at least one of said submodules comprises a plurality of firedoor elements, each associated with one of said Nᵢ links.

5. The arrangement of claim 1 where said firedoor module i is physically distinct from said one or more periphery elements of said sub-network i.

6. The arrangement of claim 5 where said firedoor module i comprises a plurality of firedoor elements, each of which is associated with one of said periphery elements.

7. The arrangement of claim 5 where said firedoor module i comprises Nᵢ firedoor elements, each of which is associated with one of said Nᵢ links.

8. The arrangement of claim 7 where each of said firedoor elements that is associated with one of said Nᵢ links is connected to said one of said Nᵢ links.

9. The arrangement of claim 7 where each of said firedoor elements that is associated with one of said Nᵢ links is interposed in said one of said Nᵢ links.

10. The arrangement of claim 5 where at least one of said periphery elements in sub-network i is a switch that includes a mirroring port, and said firedoor module i is connected to said mirroring port.

11. The arrangement of claim 5 where at least one of said periphery elements in sub-network i is a switch that includes a mirroring port, and said firedoor module i comprises a plurality of firedoor elements, one of which is connected to said mirroring port.

12. The arrangement of claim 10 where said mirroring port reflects traffic of one of said links that is connected to said switch.

13. The arrangement of claim 10 where said mirroring port reflects traffic of all of said link s that are connected to said switch.

14. The arrangement of claim 13 where said mirroring port reflects sampled traffic of all of said links that are connected to said switch on a time multiplexed basis, or of all ports of said periphery element on a time multiplexed basis.

15. The arrangement of claim 10 where said mirroring port reflects traffic of all of said links that are connected to said switch on a time multiplexed basis, or of all ports of said periphery element on a time multiplexed basis, and firedoor module i samples traffic received via said mirroring port.

16. The arrangement of claim 1 where said firedoor module i that blocks effects of all known malfeasing data aimed to flow into said sub-network i through said Nᵢ links by preventing said malfeasing data from passing through said Nᵢ links into said sub-network i.

17. The arrangement of claim 1 where said firedoor module i includes a firedoor element that is associated with a periphery element of said one or more periphery elements of sub-network i, and said firedoor element directs its associated periphery element to nullify effects of, or reject, said malfeasing data.

18. The arrangement of claim 17 where said firedoor element directs its associated periphery element through a control port of said periphery element.

19. The arrangement of claim 1 where said firedoor module i comprises a firedoor element that is associated with a periphery element of said one or more periphery elements of sub-network i, and adapted to direct its associated periphery element to block traffic of a particular type.

20. The arrangement of claim 19 where said firedoor element directs its associated periphery element through a control port of said periphery element.

21. The arrangement of claim 1 further comprising a firedoor keeper that is either inaccessible over said network or said other networks, or is accessible through said network or through said other networks only over a secure connection, by an authorized user, and said firedoor modules of said sub-networks communicate with said firedoor keeper.

22. The arrangement of claim 21 where said firedoor keeper communicates to all firedoor elements and firedoor modules information about detecting presence of known threats and actions to be taken upon discovery of such threats in monitored data.

23. The arrangement of claim 21 where said firedoor keeper directs said firedoor module i to block all data that meets preselected criteria.

24. The arrangement of claim 21 where said firedoor module i is further adapted to block traffic seeking to flow out of said sub-network i when said firedoor module i concludes that a likelihood exists that malfeasing data aims to flow out of said sub-network i, and to inform said firedoor keeper of said conclusion.

25. The arrangement of claim 21 where said secure connections employ encryption of communication.

26. The arrangement of claim 25 where said firedoor modules of said sub-networks receive from said firedoor keeper, over said secure connections, configuration file updates that provide each of said firedoor modules with information to detect said malfeasing data.

27. The arrangement of claim 21 where said firedoor modules of said sub-networks receive from said firedoor keeper configuration file updates that provide each of said firedoor modules with information to detect said malfeasing data and to take protective action.

28. The arrangement of claim 21 where said firedoor module i receives from said firedoor keeper information to direct said periphery switch to reject traffic of a specified type.

29. The arrangement of claim 21 where said firedoor module i is adapted to send to said firedoor keeper information about traffic that is indicative of, or may be indicative of, malfeasing data having gained access said sub-network i.

30. A method executed in a network that includes a plurality of interconnected switches and processing units connected to said switches, where said network is partitioned into sub-networks that are interconnected via links, said network further including a firedoor element associated with each of said links, said firedoor elements adapted for communication with a firedoor keeper, comprising the steps of:
each said firedoor element:
scanning traffic of its associated link for appearance of any attack from a group of attacks maintained in a patterns file;
taking protective action relative to traffic on its associated link when a attack from said group of attacks appears in said traffic;
reporting to said firedoor keeper when a attack appears in said traffic; and
accepting directives and updates to said patterns file from said firedoor keeper.

31. The method of claim 30 further comprising the step of:
said firedoor keeper:
receiving a report from said firedoor element associated with each of said links that detects appearance of a attack;
analyzing said report to determine whether a directive needs to be sent out, or an update to said patterns file needs to be updated;
creating said directive, or said updated patterns file; and
sending said direction or updated patterns file to said firedoor elements.

32. The method of claim 30 where said step of said firedoor element reporting includes said firedoor reporting to said firedoor keeper when a attack is suspected to be appearing in said traffic.

33. A method carried out by a firedoor apparatus comprising the steps of:
scaning traffic applied to said apparatus to detect existence in said traffic of a pattern maintained in a patterns file;
when detecting a pattern in said traffic that is maintained in said patterns file, it being a detected pattern, retrieving an action from said patterns file that is associated with said detected pattern,
executing said action;
reporting to a firedoor keeper information about said detected pattern when predetermined conditions are met.

34. The method of claim 33 further comprising receiving instructions from said firedoor keeper, and executing said instructions.

35. The method of claim 34 where said instructions are to update said patterns file, or to take immediate action regarding said traffic.

36. The method of claim 33 further comprising a step of analyzing said traffic that is scanned by said step of scanning to identify traffic that meets predetermined suspicion criteria and to trigger (a) said step of executing to take action relative to said traffic, which action relates to said suspicion criteria, and (b) said step of reporting.

37. The method of claim 36 where said suspicion criteria are embedded in a pattern in said patterns file.

38. The method of claim 36 further comprising receiving instructions from said firedoorkeeper to update said suspicion criteria and corresponding action.

39. The method of claim 33 further comprising a step of controlling behavior of a device distinct from said firedoor apparatus, which device is associated with said traffic.

40. The method of claim 39 where said step of controlling behavior of said device comprises a directive to
a. disable all traffic through said device,
b. disable all traffic relative to a source address of said traffic, or relative to destination address of said, or
c. disable all traffic of a selected type.

41. The method of claim 39 where said device is a switch having a plurality of ports, and said step of controlling behavior of said device comprises a directive to couple traffic of a specified one of said ports to said firedoor.

42. A firedoor apparatus comprising:
a firedoors patterns file that maintains a collection of information patterns and associated actions;
a controller that scans traffic applied to said apparatus to detect existence in said traffic of any of said patterns maintained in said patterns file and responds, when existence of a pattern maintained in said patterns file is detected in said traffic, it being a detected pattern, with action specified in said patterns file in association with said detected pattern; and
a communication module for reporting to a firedoor keeper detection of said detected pattern when predetermined conditions are met.

43. The firedoor apparatus of claim 42 where said controller also scans said traffic for patterns that meet predetermined suspicion criteria, and said action module responds, following detection of a traffic pattern that meets said predetermined suspicion criteria with predetermined action that is tailored to said suspicion criteria.

44. The firedoor apparatus of claim 42 further comprising a receiving module, for receiving updates from said firedoor keeper to said patterns file and for installing said updates in said patterns file.

45. The firedoor apparatus of claim 44 where said receiving module receives updates to modules that define operation of said controller and updates processing capabilities of said controller.

46. The firedoor apparatus of claim 44 where said receiving module receives immediate actions to be taken vis-à-vis said traffic.

47. The firedoor apparatus of claim 42 further comprising a control port through which said action module exercises control over a device that is associated with said traffic scanned by said controller.

48. The firedoor apparatus of claim 47 where said control that is exercised by said action module includes directing said device to
a. disable all traffic through said device,
b. disable all traffic relative to a source address of said traffic, or relative to destination address of said, or
c. disable all traffic of a selected type.

49. The firedoor of claim 47 where said device is a switch having a plurality of ports, and said action module directs said switch to make said traffic scanned by said controller correspond to traffic of a specified port of said switch.

50. A method, carried out by a firedoor keeper that is adapted to communicate with a plurality of firedoors comprising the steps of:
receiving from one of said firedoors information about an attempted communication of malfeasing data;
analyzing said information to determine whether no instructions are necessary to be sent, or whether instructions are necessary to be sent to said one of said firedoors, or to all of said firedoors;
when said step of analyzing determines that instructions are necessary to be sent, creating said instructions and sending said instructions to said one of said firedoors, or to all of said firedoors, as determined by said step of analyzing.

51. The method of claim 50 further comprising a step of receiving update data that comprises information about new malfeasing data and actions to be taken when said new malfeasing data is found, and sending said update data to all of said firedoors.

52. The method of claim 51 where said update data is provided by an administrator who is coupled to said firedoor keeper, or provided electronically from a trusted source.

53. The method of claim 50 where said step of analyzing is adapted to determine that said information represents an attack by malfeasing data that has not been previously known.

54. The method of claim 50 where said information arrives at said firedoor keeper in encrypted form, and said step of creating said instructions creates said instructions in encrypted form.

55. A firedoor keeper comprising:
a module for receiving packet data that informs said firedoor of malfeasing data an controller that
(a) analyzes said packet data to determine whether instructions are necessary to be sent out.
(b) constructs an instructions message when said controller determines that instructions are necessary to be sent out; and
a module for send out said instructions, addressed to a given device, or in a broadcasted to a set of devices.

56. The firedoor keeper of claim 55 further comprising a user interface module for enabling an administrator to assist said controller to analyze said packet data and to construct said instructions.

57. The firedoor keeper of claim 55 further comprising a memory that includes:
a patterns file that said firedoor keeper sends to all firedoors that communicate with said firedoor;
a processing modules collection that that said firedoor keeper sends to all firedoors that communicate with said firedoor;
a patterns file employed by said firedoor keeper;
a processing modules collection employed by said firedoor keeper; and
a information about messages received by said firedoor keeper form said firedoors.
